(19) United States
(12) Patent Application Publication
(10) Pub. No.: US 2024/0337550 A1
(43) Pub. Date: Oct. 10, 2024

(54) METHOD FOR NON-INTRUSIVE MEASUREMENT OF THE INTERNAL PRESSURE VARIATION AND/OR TEMPERATURE VARIATION OF A PIPE, ASSOCIATED MEASUREMENT DEVICE AND APPARATUS

(71) Applicant: COMMISSARIAT A L'ENERGIE ATOMIQUE ET AUX ENERGIES ALTERNATIVES, Paris (FR)

(72) Inventor: Laurent MAURIN, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/292,074

(22) PCT Filed: Jul. 26, 2022
(86) PCT No.: PCT/EP2022/070949

§ 371 Date: Jan. 25, 2024

(30) Foreign Application Priority Data
Jul. 29, 2021 (FR) FR21 08269

(51) Int. Cl. G01L 11/02; G01L 1/24

(52) U.S. Cl. CPC G01L 11/025; G01L 1/246

(57) ABSTRACT

A method for measuring a variation in an internal pressure and/or a variation in a temperature of a pipe including a portion includes calculating the variation in the internal pressure and/or the variation in the temperature of the pipe based on at least one deformation variation, each deformation variation being obtained only from measured monitoring variables among which first and second ones are associated with first and second measurement directions, respectively. The first and second measurement directions define first and second angles with a plane normal to the longitudinal axis having different absolute values modulo π.

### TECHNICAL FIELD

The present invention relates to a method for measuring a variation in an internal pressure and/or a variation in the temperature of a pipe.

The invention applies to the field of instrumentation, and more specifically to the non-intrusive measurement of a variation in the hydrostatic pressure prevailing inside a pipe from outside thereof.

### PRIOR ART

There is a need to perform a non-intrusive measurement of a variation in the hydrostatic pressure prevailing inside a pipe from outside thereof. For example, such a pipe is a pipeline used for transporting hydrocarbons, a primary or secondary circuit of a nuclear reactor, a pressurised fluid (liquid or gas) supply network (industrial site, agglomeration, machine, etc.), or else a pressurized cylindrical reservoir, for example used for the storage of a fluid (for example: hydrogen) under high pressure.

The document FR 2 864 202 B1 describes a method for measuring a variation in the internal pressure of a pipe implementing sensors configured to measure a variation in the total deformation of the pipe (comprising a deformation mechanical component and a deformation thermal component), and an additional sensor for determining the deformation variation thermal component and thus subtracting it from the total deformation variation measurement.

Such an additional sensor is adhered to a sample made of the same material as the pipe, distinct from the latter, and subjected to the same temperature as said pipe, so that the variations in the total deformations measured by the additional sensor do not comprise any deformation mechanical component.

The internal pressure variation is calculated from the deformation variation mechanical component obtained by subtracting the thermal component from the total deformation variation.

Nevertheless, such a measurement method is not fully satisfactory.

Indeed, the implementation of such an additional sensor does not allow satisfactorily compensating for the thermal effects on the sensors for measuring the mechanical deformation variation of the pipe under pressure, and has some defects that result in introducing a bias in the pressure variation measurement, which is difficult to correct.

First, the method of the prior art requires at least three independent measurements, which multiplies the sources of uncertainties.

Besides, it proves to be difficult, and even impossible, to provide a sample of the material making up the pipe of an already existing installation, in order to determine the thermal component of the total deformation variation. Yet, it is essential that the sample has the same coefficient of thermal expansions that of the pipe, so that the thermal component of the total deformation variation could be sufficiently subtracted therefrom in a sufficiently perfect manner over the entirety of the considered temperature range.

Furthermore, because of its thermal inertia, different from that of the deformation sensors positioned on the pipe (in particular because of the presence of a pressurized fluid inside the latter), the use of such an additional sensor introduces a variable delay in the compensation of the thermal effects, and therefore a systematic measurement error as soon as the temperature varies, even in a slow manner.

Yet, in the context of such applications, where the temperatures could vary from several tens of degrees Celsius, the mechanical component of the total deformation could be obscured by a signal of thermal origin becoming dominant, and, in such a case, it is impossible to perform a reliable measurement of the pressure variation.

Thus, for example, when the deformation sensors consist of Bragg gratings adhered at the surface of a pipe made of austenitic steel having a diameter 4 inches in Schedule 160 (wall thickness of 13.49 mm), having a coefficient of thermal expansion in the range of 16,4×10⁻⁶ K⁻¹ (per kelvin), a temperature uncertainty of one Kelvin results in an error of 28 bar on the measurement of the internal pressure variation.

Hence, the invention aims to provide a method for measuring the variation in the internal pressure and/or in a temperature of a pipe which is less affected by the effects of the variations in the thermal deformations (induced by the temperature variations, or mechanical in the case of temperature measurement) during the calculation of the variation in the mechanical deformation/in the temperature of the pipe, resulting in a more reliable estimation of the variation in the internal pressure and/or in the temperature of the pipe.

### DISCLOSURE OF THE INVENTION

To this end, an object of the invention is a method for measuring a variation in an internal pressure and/or a variation in the temperature of a pipe including a portion extending along a longitudinal axis, the measurement method comprising the steps:
for each of at least two measurement areas of the portion of the pipe, measuring, by means of a corresponding sensor, a monitoring quantity associated with a respective measurement direction, a relative variation in the monitoring quantity being representative of a variation in a corresponding local deformation of the pipe according to the associated measurement direction; and
calculating the variation in the internal pressure and/or the variation in the temperature of the pipe based on at least one deformation variation, each deformation variation being obtained only from measured monitoring quantities, among which at least one first measured monitoring quantity is associated with a first measurement direction and at least one second measured monitoring quantity is associated with a second measurement direction,
the first measurement direction defining a first angle with a plane normal to the longitudinal axis, the second measurement direction defining a second angle with a plane normal to the longitudinal axis, the first angle and the second angle having different absolute values modulo π,
the sensors being selected so that the same temperature variation results in the same relative variation of their respective measured monitoring quantities.

It should be noted that, of course, the at least two measurement areas could be distinct or coincident without departing from the scope of the invention, bearing in mind that, as required by the invention, the first angle and the second angle have different absolute values modulo π.

Indeed, such a measurement method exploits the intrinsic property of the pipe under hydrostatic stress of having two sensitivities in significantly different mechanical deformations according to its length (longitudinal mechanical deformation) and its circumference (orthoradial mechanical deformation).

Thus, the monitoring quantities measured for two different measurement angles are representative of different mechanical deformation variations.

On the other hand, the contribution of the temperature variation to its total deformation variation may be considered identical for each of the measurement areas of the pipe.

Yet, the sensors are selected so as to have an identical temperature sensitivity (i.e. the same relative variation of their respective monitoring quantity for the same temperature variation). Thus, a simple subtraction using the tracking quantities for two different measurement angles suppresses the dependence of the measurement of the total deformation variation on temperature, which directly results in a measurement of the variation in the deformation mechanical component of the pipe under pressure.

Thus, assuming that the pipe remains in its elastic domain, and by application of Hooke's law, obtaining the variation in the deformation mechanical component amounts to calculating a variation in the internal pressure, completely independent of the effects of the temperature variation, to the extent that the variation in the additional longitudinal force and the variation in the external pressure are known, or deemed to be negligible. Another assumption is that the pipe is closed at each of its ends (thereby forming a pressure reservoir), which, in practice, is always the case.

Thus, thanks to the measurement method object of the invention, the problem of the dependence of the measurement of the variation in the deformation of the pipe on temperature (and that of the dependence of the temperature variation measurement on the deformation of the pipe) is intrinsically resolved, providing in a dual manner the contact temperature variation information independently of the pressure variation, and also, this method can be implemented by means of only two sensors.

Still more generally, considering the principle on which the compensation of the thermal effects is based, any external effect other than that of the temperature, also disturbing in an identical manner the measurement of each of the sensors, is eliminated by this means, or, to the very least, has quite substantially attenuated, in a totally intrinsic manner. Therefore, such a method may also be implemented for measuring a variation in the internal pressure of a pipe arranged in radiative environments, i.e. when the pipe is subjected to ionizing radiations, and more generally, in environments where any disturbing effect on the measurement of the mechanical deformation of the pipe has an identical effect on the measurement of each of the sensors.

According to other advantageous aspects of the invention, the measurement method includes one or more of the following features, considered separately or according to any technically-feasible combination:
the measurement step is preceded by fastening the corresponding sensor at each measurement area,
the sensors being fastened at their respective measurement areas according to the same fastening method and being selected so that the same variation of a mechanical deformation applied thereto results in the same relative variation of their respective measured monitoring quantities,
the method enables the measurement of an internal pressure variation of the pipe, and the portion of the pipe has an axisymmetric cylindrical shape, each measurement area belonging to a section of the portion of the pipe, the pipe being closed at its ends,
the variation of the internal pressure being calculated according to:

$$Δ {P}_{int} Δ {P}_{ext} + \frac{{r}_{1}^{2} {r}_{2}^{2}}{{r}_{0 , int}^{2} {r}_{0 , ext}^{2}} [ \text{} \frac{E ( Δ {Ψ}_{2} - {ΔΨ}_{1} ) ( {r}_{0 , ext}^{2} - {r}_{0 , int}^{2} )}{{κ}_{E} ( 1 + v ) [ {r}_{1}^{2} {cos}^{2} ( {ϕ}_{2} ) - {r}_{2}^{2} {cos}^{2} ( {ϕ}_{1} ) ]} + \frac{{cos}^{2} ( {ϕ}_{2} ) - {cos}^{2} ( {ϕ}_{1} )}{π [ {r}_{1}^{2} {cos}^{2} ( {ϕ}_{2} ) - {r}_{2}^{2} {cos}^{2} ( {ϕ}_{1} ) ]} δ F ]$$

where ΔPᵢₙₜ is the variation of the internal pressure;
ΔΨ₁ and ΔΨ₂ are respectively a relative variation of the first monitoring quantity and a relative variation of the second monitoring quantity;
r_{0,ext} is an outer radius of the portion of the pipe;
r_{0,int} is an inner radius of the portion of the pipe;
r₁ is a radius at which the measurement associated with the first measurement direction is performed;
r₂ is a radius at which the measurement associated with the second measurement direction is performed;
E is the Young's modulus of the material in which the portion (12) of the pipe (4) is made;
v is the Poisson's ratio of the material in which the portion of the pipe is made;
ϕ₁ and ϕ₂ are respectively the first angle and the second angle;
ΔPₑₓₜ is a variation in an external pressure applied to the portion of the pipe;
δF is a variation in an additional longitudinal force applied to the portion of the pipe and distinct from a variation in a longitudinal force exerted on the portion of the pipe by the internal pressure variation and the external pressure variation; and
κ_{ε} is a mechanical sensitivity of the sensors, equal to a proportionality coefficient between a relative variation in the monitoring quantity and a variation in the mechanical deformation applied thereto;
the corresponding sensor is an optical fibre segment in which a Bragg grating is inscribed, the optical fibre segment being fastened to the measurement area so that the corresponding Bragg grating extends along the measurement direction associated with said measurement area,
the mechanical sensitivity κ_{ε} being expressed as:

$${κ}_{ε} = \frac{1}{{n}_{eff}} \frac{\partial {n}_{eff}}{\partial {ε}_{mec}} + 1$$

where n_{eff} is an effective index of the optical guide of the optical fibre; and
ε_{mec} is a longitudinal mechanical deformation of the optical fibre,
the monitoring quantity being a reflection wavelength of each Bragg grating;
for at least two measurement areas, the corresponding optical fibre segments belong to the same optical fibre;
the measurement axes associated with at least two optical fibre segments of the same optical fibre form, with the longitudinal axis of the portion of the pipe, distinct angles, in absolute values, modulo π;
the measurement areas on which at least two optical fibre segments of the same optical fibre are fastened are arranged along a generatrix of the portion of the pipe;
for at least one measurement area, the sensor is selected from the group comprising the distance sensors such as a sensor implementing an acoustic method between an acoustic emitter and an acoustic receiver, the sensors implementing a reflectometry method on an electrical cable, the sensors implementing an optical reflectometry method, the strain gauges, such as the electrical deformation gauges, and the stereo-correlation deformation sensors;
the first angle amounts to 0 modulo π, and the second angle amounts to π/2 modulo π;
the method enables the measurement of a variation in the temperature of the pipe and the portion of the pipe has an axisymmetric cylindrical shape, each measurement area belonging to a section of the portion of the pipe, the pipe being closed at its ends,
the variation in the temperature of the pipe being calculated according to:

$$Δ T = \frac{{r}_{1}^{2} {r}_{2}^{2} ( Δ {Ψ}_{1} - Δ {Ψ}_{2} ) ( {κ}_{ε} ( 1 - 2 v ) - {κ}_{P} E )}{{κ}_{T} {κ}_{ε} ( 1 + v ) {r}_{0 , ext}^{2} [ {r}_{1}^{2} {cos}^{2} ( {ϕ}_{2} ) - {r}_{2}^{2} {cos}^{2} ( {ϕ}_{1} ) ]} + \frac{Δ {Ψ}_{1} {r}_{1}^{2} {cos}^{2} ( {ϕ}_{2} ) - Δ {Ψ}_{2} {r}_{2}^{2} {cos}^{2} ( {ϕ}_{1} )}{{κ}_{τ} [ {r}_{1}^{2} {cos}^{2} ( {ϕ}_{2} ) - {r}_{2}^{2} {cos}^{2} ( {ϕ}_{1} ) ]} + \frac{1}{{κ}_{τ}} ( \frac{1 - 2 v}{E} {κ}_{ε} - {κ}_{P} ) Δ {P}_{ext} + \frac{\begin{matrix}{κ}_{ε} [ ( {r}_{2}^{2} - {r}_{1}^{2} ) ( {cos}^{2} ( {ϕ}_{1} ) + {cos}^{2} ( {ϕ}_{2} ) - 2 ( 1 + v ) {cos}^{2} ( {ϕ}_{1} ) {cos}^{2} ( {ϕ}_{2} ) ) + \\ ( {r}_{2}^{2} + {r}_{1}^{2} ) ( {cos}^{2} ( {ϕ}_{1} ) + {cos}^{2} ( {ϕ}_{2} ) ) ]\end{matrix}}{2 {κ}_{τ} π E ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} \underline{δ F} - \frac{1}{{κ}_{τ}} ( \frac{1 - 2 v}{E} {κ}_{ε} - {κ}_{P} ) \frac{{r}_{1}^{2} {r}_{2}^{2} [ {cos}^{2} ( {ϕ}_{2} ) - {cos}^{2} ( {ϕ}_{1} ) ]}{π {r}_{0 , ext}^{2} ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} \underline{δ F} + {ϵ}_{surf} \frac{1}{{κ}_{τ}} ( \frac{{κ}_{P}}{π ( {r}_{0 , ext}^{2} - {r}_{0 , int}^{2} )} \underline{δ F} - \frac{( Δ {Ψ}_{1} - Δ {Ψ}_{2} ) {κ}_{P} E}{{κ}_{ε} ( 1 + v ) [ {cos}^{2} ( {ϕ}_{2} ) - {cos}^{2} ( {ϕ}_{1} ) ]} )$$

where ΔT is the variation in the temperature of the pipe; ΔΨ₁ and ΔΨ₂ are respectively a relative variation of the first monitoring quantity and a relative variation of the second monitoring quantity;
r_{0,ext} is an outer radius of the portion of the pipe;
r_{0,int} is an inner radius of the portion of the pipe;
r₁ is a radius at which the measurement associated with the first measurement direction is performed;
r₂ is a radius at which the measurement associated with the second measurement direction is performed;
∈_{surf} is a parameter which takes the value 1 when r₁ and r₂ are both equal to r_{0,int} or both equal to r_{0,ext} and the value 0 in the other cases;
E is the Young's modulus of the material in which the portion of the pipe is made;
v is the Poisson's ratio of the material in which the portion of the pipe is made;
ϕ₁ and ϕ₂ are respectively the first angle and the second angle;
ΔPₑₓₜ is a variation in an external pressure applied to the portion of the pipe;
δF is a variation in an additional longitudinal force applied to the portion of the pipe and distinct from a variation in a longitudinal force exerted on the portion of the pipe by the internal pressure variation and the external pressure variation;
κ_{ε} is a mechanical sensitivity of the sensors, equal to a proportionality coefficient between a relative variation in the monitoring quantity and a mechanical deformation variation;
κ_{T} is a thermal sensitivity of the sensors, equal to a proportionality coefficient between a relative variation in the monitoring quantity and a variation in their temperature; and
κ_{P} is a sensitivity intrinsic to the hydrostatic pressure of the sensor alone, said sensitivity being equal to a proportionality coefficient between a relative variation in the monitoring quantity and a variation in the hydrostatic pressure that is directly applied thereto;
N measurement areas are circumferentially distributed every 2π/N around the longitudinal axis, N being an integer strictly greater than 1 and, preferably, N being an even number greater than 2, for at least two distinct measurement areas, the corresponding monitoring quantities are associated with measurement directions defining, with a plane normal to the longitudinal axis, angles with opposite signs modulo π;
the measurement associated with the first measurement direction and the measurement associated with the second measurement direction are performed at the same surface of the portion selected from among an inner surface and an outer surface of said pipe portion;
the method further comprising the steps of:
measuring, by means of a pressure sensor arranged in the pipe, a pressure of a fluid present in the pipe, forming a reference pressure; and
calculating a damage parameter based on a discrepancy between the variation in the calculated internal pressure and a concomitant variation in the measured reference pressure,
the measurement method advantageously comprising generating an alert signal if the determined damage parameter is outside a predetermined tolerance range.

Furthermore, an object of the invention is a device for measuring a variation in an internal pressure of a pipe including a portion extending along a longitudinal axis, the measurement device comprising at least two sensors and a calculator,
each sensor being configured so as to output, for a corresponding measurement area of the portion of the pipe, a measurement signal indicative of a predetermined monitoring quantity associated with a respective measurement direction, a relative variation in the monitoring quantity being representative of a variation in a local deformation, according to the associated measurement direction, of the measurement area,
the sensors being selected so that the same temperature variation results in the same relative variation in their respective measured monitoring quantities,
the computer being configured to measure the corresponding monitoring quantity based on each measurement signal,
the computer being further configured to calculate the variation in the internal pressure of the pipe based on at least one deformation variation, each deformation variation being obtained only from measured monitoring quantities, among which at least one first measured monitoring quantity is associated with a first measurement direction and at least one second measured monitoring quantity is associated with a second measurement direction,
the first measurement direction defining a first angle with a plane normal to the longitudinal axis, the second measurement direction defining a second angle with a plane normal to the longitudinal axis, the first angle and the second angle having different absolute values modulo π.

Another object of the invention is a set comprising a pipe and a measurement device according to the invention, the pipe including a portion extending along a longitudinal axis,
each sensor of the measurement device being associated with a respective measurement area of an outer surface of the portion of the pipe, and being arranged so as to provide a monitoring quantity associated with a respective measurement direction, a relative variation in the monitoring quantity being representative of a variation in a corresponding local deformation of the pipe according to the associated measurement direction
at least one first measurement direction defining a first angle with a plane normal to the longitudinal axis, and at least one second measurement direction defining a second angle with the plane normal to the longitudinal axis, the first angle and the second angle having different absolute values modulo π.

### BRIEF DESCRIPTION OF THE DRAWINGS

The invention will be better understood from the following description, given only as a non-limiting example and made with reference to the appended drawings wherein:

FIG. 1 is a schematic illustration of an apparatus comprising a pipe and a measurement device according to the invention, sensors of the measurement device being arranged in a helix-like fashion around the pipe;

FIG. 2 is similar to FIG. 1, the sensors of the measurement device being arranged in a ring-like fashion around the pipe; and

FIG. 3 is similar to FIG. 1, the sensors of the measurement device being arranged along a generatrix of the pipe.

### DETAILED DESCRIPTION

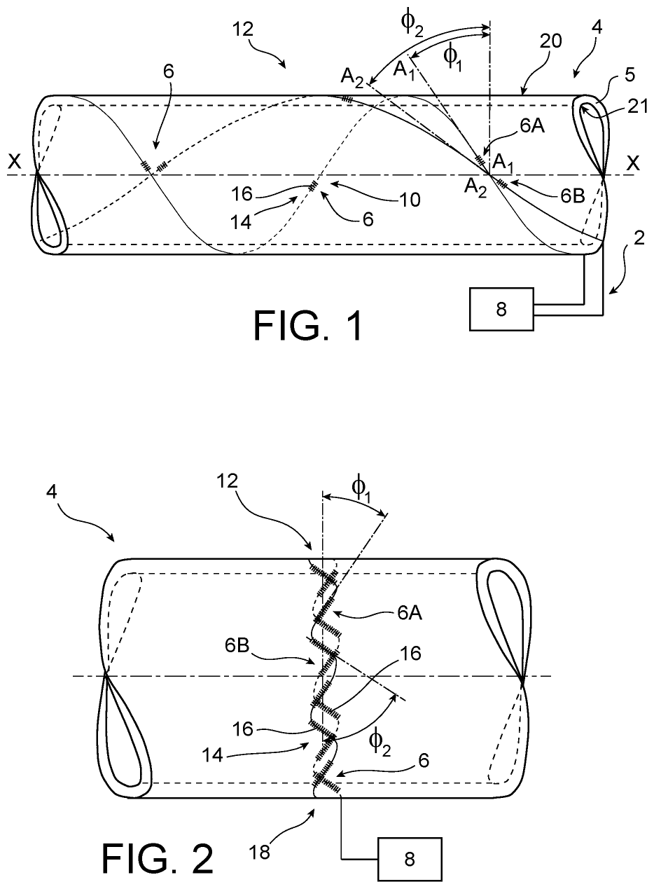

A measurement device 2 according to the invention is illustrated by FIG. 1. The measurement device 2 is intended for measuring a variation ΔPᵢₙₜ in an internal pressure Pᵢₙₜ of a pipe 4, i.e. for measuring the variation in the pressure of a fluid present in said pipe 4 and/or a variation ΔT in a temperature of this same pipe 4. The pressure of the fluid present in said pipe 4 is also referred to as “hydrostatic pressure”. Such a measurement device 2 equips an installation 1 comprising the pipe 4 in addition to the measurement device 2.

The present disclosure focuses on the measurement of the internal pressure variation, the possibility of measuring the variation in the temperature of the pipe 4 being described later on, complementarily with the internal pressure measurement. Of course, even though the temperature variation measurement is described complementarily with the internal pressure variation measurement in the present disclosure, one could perfectly consider, without departing from the scope of the invention, exploiting this temperature variation measurement alone and independently of the internal pressure variation measurement.

Such a pipe 4 includes a wall 5 having a cross-section with a closed contour, defining an outer surface 20 and an inner surface 21 of the pipe 4, a portion 12 of which extends along a longitudinal axis X-X.

As illustrated by FIG. 1, the measurement device 2 comprises at least two sensors 6 and a calculator 8.

Each sensor 6 is associated with a measurement area 10 of the portion 12 of the pipe 4, and is intended to output a measurement signal corresponding to said measurement area 10. Such a measurement area 10 is a portion of the outer surface 20 of the pipe 4, of its inner surface 21, or is located across the thickness of its wall 5. Furthermore, the calculator 8 is configured to determine the variation ΔPᵢₙₜ in the internal pressure of the pipe 4 based on the measurement signals received from the sensors 6.

For each measurement area 10, the corresponding sensor 6 is associated with a respective measurement direction, bearing, for example, the reference A₁-A₁ or A₂-A₂ in FIG. 1. As regards the sensor 6, the corresponding measurement signal is indicative of a predetermined monitoring quantity. Furthermore, for each sensor 6, the corresponding monitoring quantity is such that a relative variation in said monitoring quantity is representative of a variation in a local deformation, according to the associated measurement direction, of the measurement area 10 associated with said sensor 6.

Among the sensors 6 of the measurement device 2, at least one first sensor 6A is associated with a first measurement direction A₁-A₁ defining a first angle ϕ₁ with a plane normal to the longitudinal axis X-X, and at least one second sensor 6B is associated with a second measurement direction A₂-A₂ defining a second angle ϕ₂ with a plane normal to the longitudinal axis X-X.

In other words, the first sensor 6A is associated with a first monitoring quantity, the relative variation of which is representative of the variation in the local deformation of the corresponding measurement area 10 according to the first measurement direction A₁-A₁ which defines the first angle ϕ₁ with a plane normal to the longitudinal axis X-X. Furthermore, the second sensor 6B is associated with the second measurement direction A₂-A₂ the relative variation of which is representative of the variation in the local deformation of the corresponding measurement area 10 according to the second measurement direction A₂-A₂ which defines the second angle ϕ₂ with a plane normal to the longitudinal axis X-X.

The first angle ϕ₁ and the second angle ϕ₂ have different values, in absolute value, modulo π.

Advantageously, the first angle ϕ₁ amounts to 0 modulo π, and the second angle ϕ₂ amounts to π/2 modulo π. These values are those resulting in the greatest measurement sensitivity in the context of the invention.

Furthermore, the sensors 6 are selected so that the same temperature variation results in the same relative variation in their respective monitoring quantities.

In this manner, since the variation in the deformation thermal component is reflected in the same manner on the measured monitoring quantities, the suppression of the effects of the thermal variations on the variations in the measured deformations of the pipe is made possible, through a simple compensation between the sensors 6.

Preferably, each sensor 6 is intended to perform such a measurement while being fastened to the corresponding measurement area 10.

In this case, the sensors 6 are advantageously fastened to their respective measurement areas 10 according to the same fastening method. Furthermore, the sensors 6 are selected so that the same mechanical deformation variation results in the same relative variation in their respective monitoring quantities.

In this manner, the sensors 6 have similar behaviours with regards to the deformation variations; discrepancies between the variations in the measured monitoring quantities, which would result in a poor estimation of the variation in the internal pressure ΔPᵢₙₜ, are thus avoided.

For example, such a fastening is achieved by sticking the sensors 6 to their respective measurement areas.

Preferably, each sensor 6 is an optical fibre segment 14 in which a Bragg grating 16 is inscribed. In this case, each optical fibre segment 14 is fastened to the corresponding measurement area 10, so that its Bragg grating 16 extends along the measurement direction associated with said sensor 6, i.e. with said measurement area 10. Furthermore, for each fiber segment 14, the associated monitoring quantity is the reflection wavelength of the corresponding Bragg grating 16.

Furthermore, to meet the conditions on the relative variation in the monitoring quantity with the temperature and the mechanical deformation, the optical fibre segments 14 are advantageously derived from the same preform. Still preferably, the segments 14 belong to the same optical fibre 18, and are distributed over this optical fibre 18.

Advantageously, the measurement axes associated with at least two optical fibre segments 14 of the same optical fibre 18 form, with a plane normal to the longitudinal axis X-X of the portion 12 of the pipe 4, angles that are distinct, in absolute value, modulo π. In this manner, a measurement of the variation in the internal pressure of the pipe 4 could be obtained by means of one single optical fibre 18.

For example, as shown in FIG. 2, the optical fibre 18 is wound in a ring-like fashion around the longitudinal axis of the portion 12. In this case, as well as in that wherein the measurement areas 10 are arranged in a helix-like fashion around the longitudinal axis, N measurement areas 10 (N being an integer strictly greater than 1) are advantageously distributed circumferentially every 2π/N around the longitudinal axis X-X, the pressure variation measurement being the result of the arithmetic mean of the pressure variation measurements performed for each of these areas. In this manner, the effects of bending of the portion 12 of the pipe 4 could be compensated.

More preferably, N being an even number greater than 2, the monitoring quantities corresponding to said measurement areas are respectively associated with measurement directions defining, with a plane normal to the longitudinal axis, angles having opposite sign modulo π. In this way, besides the compensation of the effects of bending of the pipe 4 on the measurement, the effects of torsion thereof could also be compensated.

In a particularly advantageous manner, to allow for a good compensation of torsion, N may be an even integer, each measurement area may have an even homologous measurement area whose measurement directions have opposite signs, the pressure variation measurement could then be the result of the arithmetic mean of the pressure variation measurements performed for each of these areas, and thus be compensated for the torsion effects.

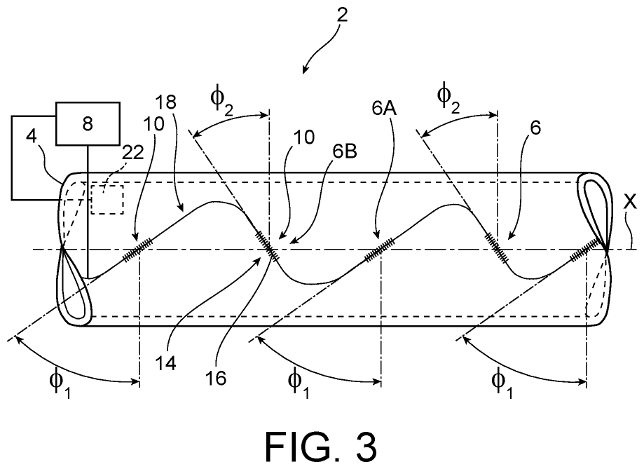

According to a variant illustrated by FIG. 3, the measurement areas 10, on which at least two optical fibre segments 14 of the same optical fibre 18 are fastened, are arranged along a generatrix of the portion 12 of the pipe 4. This is advantageous, to the extent that only part of the pipe 4 is accessible, making winding of the optical fibre 18 over its circumference tedious, and even impossible. The optical fibre segments 14 are then arranged in contact with and mechanically secured to the accessible portion of the pipe 4.

According to another example, for at least one measurement area 10, the corresponding sensor 6 is a distance sensor, such as a sensor implementing a method for measuring an acoustic distance between an acoustic emitter and an acoustic receiver. In this case, the monitoring quantity is the distance measured by the sensor 6.

Alternatively, the sensor 6 is a sensor implementing a reflectometry method on an electrical cable, a sensor implementing an optical reflectometry method, an electrical deformation gauge.

Alternatively, the sensor 6 is able to perform the measurement of the monitoring quantity without being fastened to the corresponding measurement area 10. This is, for example, the case of a stereo-correlation deformation sensor.

As indicated before, the calculator 8 is configured to determine the variation ΔPᵢₙₜ in the internal pressure of the pipe 4 based on the measurement signals received from the sensors 6.

More specifically, for each sensor 6, the calculator 8 is configured to measure the corresponding monitoring quantity based on the measurement signal that it outputs.

Furthermore, the calculator 8 is configured to calculate the variation ΔPᵢₙₜ in the internal pressure of the pipe 4 based on at least one deformation variation, each deformation variation being obtained only from measured monitoring quantities obtained directly from the pipe 4 itself.

Preferably, besides the deformation variations, the calculator 8 is configured to implement a variation ΔPₑₓₜ in an external pressure Pₑₓₜ and a variation in an additional longitudinal force 5F applied to the portion 12 of the pipe 4 for calculating the variation ΔPᵢₙₜ in the internal pressure of the pipe 4.

The measured monitoring quantities implemented by the calculator 8 comprise at least one first measured monitoring quantity associated with the sensor 6A (i.e. for which the respective first measurement direction defines the first angle ϕ₁ with the plane normal to the longitudinal axis) and a second measured monitoring quantity associated with the sensor 6B (i.e. for which the second measurement direction defines the second angle ϕ₂ with the plane normal to the longitudinal axis X-X).

In this case, the variation in the additional longitudinal force 5F is defined as the variation in a longitudinal force exerted on the portion 12 of the pipe 4, and which is distinct from the variation in a longitudinal force exerted on said portion 12 only by the variations in the internal Pᵢₙₜ and external Pₑₓₜ pressures.

In the particular case where the portion 12 of the pipe 4 has an axisymmetric cylindrical shape, each measurement area 10 belonging to an outer surface 20 of the portion 12 of the pipe, the pipe being closed at its ends, the calculator 8 is configured to calculate the variation in the internal pressure ΔPᵢₙₜ according to:

$$Δ {P}_{int} = Δ {P}_{ext} + \frac{{r}_{0 , ext}^{2} E ( Δ {Ψ}_{{2}^{-}} Δ {Ψ}_{1} )}{{κ}_{ε} ( 1 + v ) [ {cos}^{2} ( {ϕ}_{2} ) - {cos}^{2} ( {ϕ}_{1} ) ]} ( \frac{1}{{r}_{0 , int}^{2}} - \frac{1}{{r}_{0 , ext}^{2}} ) + \frac{δ F}{π {r}_{0 , int}^{2}}$$

where ΔΨ₁ and ΔΨ₂ are respectively a relative variation in the first monitoring quantity and a relative variation in the second monitoring quantity;
r_{0,ext} is an outer radius of the portion 12 of the pipe 4;
r_{0,int} is an inner radius of the portion 12 of the pipe 4;
E and v are respectively the Young's modulus and the Poisson's ratio of the material in which the portion 12 of the pipe 4 is made;
k_{ε} is a mechanical sensitivity of the sensors, equal to a proportionality coefficient between a relative variation in the monitoring quantity and a mechanical deformation variation; and
δF is a variation in an additional longitudinal force applied to the portion of the pipe and distinct from a variation in a longitudinal force exerted on the portion of the pipe by the internal pressure variation and the external pressure variation.

In the case where the sensors 6 are positioned across the thickness of the pipe at the same radius r:

$$Δ {P}_{int} = Δ {P}_{ext} + \frac{{r}^{2} E ( Δ {Ψ}_{{2}^{-}} Δ {Ψ}_{1} )}{{κ}_{ε} ( 1 + v ) [ {cos}^{2} ( {ϕ}_{2} ) - {cos}^{2} ( {ϕ}_{1} ) ]} ( \frac{1}{{r}_{0 , int}^{2}} - \frac{1}{{r}_{0 , ext}^{2}} ) + \frac{{r}^{2}}{π {r}_{0 , int}^{2} {r}_{0 , ext}^{2}} δ F$$

where r is a radius at which the first and second sensors 6 are positioned, and which is therefore associated with the first and second measurement areas 10, in other words with the first and second measurements.

And in the more general case where the first and second sensors 6 are positioned across the thickness or at the surface of the pipe, respectively at a radius r₁ and a radius r₂

$$Δ {P}_{int} = Δ {P}_{ext} + \frac{{r}_{1}^{2} {r}_{2}^{2}}{{r}_{0 , int}^{2} {r}_{0 , ext}^{2}} [ \text{} \frac{E ( Δ {Ψ}_{{2}^{-}} Δ {Ψ}_{1} ) ( {r}_{0 , ext}^{2} - {r}_{0 , int}^{2} )}{{κ}_{ε} ( 1 + v ) [ {r}_{1}^{2} {cos}^{2} ( {ϕ}_{2} ) - {r}_{2}^{2} {cos}^{2} ( {ϕ}_{1} ) ]} + \frac{{cos}^{2} ( {ϕ}_{2} ) - {cos}^{2} ( {ϕ}_{1} )}{π [ {r}_{1}^{2} {cos}^{2} ( {ϕ}_{2} ) - {r}_{2}^{2} {cos}^{2} ( {ϕ}_{1} ) ]} δ F ]$$

where r₁ is a radius at which the first sensor 6 is positioned, which is therefore associated with the first measurement area 10 and with the first measurement;
r₂ is a radius at which the second sensor 6 is positioned, which is therefore associated with the second measurement area 10 and with the second measurement.

Of course, it should be noted that the values of the radii r_{0,int}, r_{0,ext}, r, r₁, and r₂ are reference values determined at the reference time point, as an initial time point, since, given the forces exerted on the pipe 4, these values are brought to evolve.

In particular, for a sensor 6 formed by an optical fibre segment 14 in which a Bragg grating 16 is inscribed, the mechanical sensitivity κ_{ε} is expressed as:

$${κ}_{ε} = \frac{1}{{n}_{eff}} \frac{\partial {n}_{eff}}{\partial {ε}_{mec}} + 1$$

where n_{eff} is an effective index of the optical guide of the optical fibre 18; and
∈_{mec} is a longitudinal mechanical deformation of the optical fibre.

In the advantageous case where, at the predetermined reference time point, the internal pressure P_{int,0} of the pipe 4 is known and recorded in a memory of the calculator 8, said calculator 8 is configured to calculate the internal pressure Pᵢₙₜ at any final time point subsequent to the initial time point by integration of the internal pressure variation ΔPᵢₙₜ, over time, between the reference time point and the final time point.

Preferably, the calculator 8 is also configured to calculate a variation in the temperature of the pipe 4 based on the measured monitoring quantities, among which at least the measured first monitoring quantity and second monitoring quantity. Advantageously, this measurement indicative of the contact temperature variation may be used together with the internal pressure variation measurement in order to prevent the formation of hydrate cloggings within pipelines used for the transport of hydrocarbons.

It should be noted that, more specifically and as indicated hereinafter, the variation in the calculated, or determined, temperature of the calculated pipe 4 is a contact temperature between the pipe (or more specifically its portion 12) and the sensors 6 corresponding to the measurement areas

More specifically, in the case where the portion 12 of the pipe 4 has an axisymmetric cylindrical shape, each measurement area 10 belonging to an outer surface 20 of the portion 12 of the pipe, the pipe 4 being closed at its ends, the calculator 8 is configured to calculate said temperature variation according to:

$$Δ T = \frac{1}{{κ}_{τ}} ( \frac{1 - 2 v}{1 + v} \frac{Δ {Ψ}_{{1}^{-}} Δ {Ψ}_{2}}{{cos}^{2} ( {ϕ}_{2} ) - {cos}^{2} ( {ϕ}_{1} )} + \frac{Δ {Ψ}_{1} {cos}^{2} ( {ϕ}_{2} ) - Δ {Ψ}_{2} {cos}^{2} ( {ϕ}_{1} )}{{cos}^{2} ( {ϕ}_{2} ) - {cos}^{2} ( {ϕ}_{1} )} + ( \frac{1 - 2 v}{E} {κ}_{ε} - {κ}_{P} ) Δ {P}_{ext} - \frac{2 {κ}_{ε} ( 1 - v )}{π E ( {r}_{0 , ext}^{2} - {r}_{0 , int}^{2} )} δ F )$$

where ΔT is the variation in the temperature of the pipe 4; and
κ_{T} is a thermal sensitivity of the sensors, equal to a proportionality coefficient between a relative variation in the monitoring quantity and a variation in their temperature.

In such a configuration, the determined temperature variation ΔT of the pipe is a contact temperature of the outer surface of the pipe 4.

In the case where the sensors are positioned at the inner surface of the pipe at the same radius r_{0,int}:

$$Δ T = \frac{1}{{κ}_{τ}} ( \frac{( Δ {Ψ}_{{1}^{-}} Δ {Ψ}_{2} ) ( {κ}_{P} E ( {r}_{0 , ext}^{2} - {r}_{0 , int}^{2} ) + {κ}_{ε} ( 1 - 2 v ) {r}_{0 , int}^{2} )}{{κ}_{ε} ( 1 + v ) {r}_{0 , ext}^{2} ( {cos}^{2} ( {ϕ}_{2} ) - {cos}^{2} ( {ϕ}_{1} ) )} + \frac{Δ {Ψ}_{1} {cos}^{2} ( {ϕ}_{2} ) - Δ {Ψ}_{2} {cos}^{2} ( {ϕ}_{1} )}{{cos}^{2} ( {ϕ}_{2} ) - {cos}^{2} ( {ϕ}_{1} )} + ( \frac{1 - 2 v}{E} {κ}_{ε} - {κ}_{P} ) Δ {P}_{ext} - \frac{1}{π E} ( \frac{{κ}_{P} E - {κ}_{ε} ( 1 - 2 v )}{{r}_{0 , ext}^{2}} + \frac{2 {κ}_{ε} ( 1 - v )}{{r}_{0 , ext}^{2} - {r}_{0 , int}^{2}} ) δ F )$$

In such a configuration, the determined temperature variation ΔT of the pipe 4 is a contact temperature of the inner surface of the pipe 4.

In the case where the sensors are positioned across the thickness of the pipe at the same radius r:

$$Δ T = \frac{1}{{κ}_{τ}} ( \frac{{r}^{2} ( Δ {Ψ}_{{1}^{-}} Δ {Ψ}_{2} ) ( {κ}_{ε} ( 1 - 2 v ) - {κ}_{P} E )}{{κ}_{ε} ( 1 + v ) {r}_{0 , ext}^{2} [ {cos}^{2} ( {ϕ}_{2} ) - {cos}^{2} ( {ϕ}_{1} ) ]} + \frac{Δ {Ψ}_{1} {cos}^{2} ( {ϕ}_{2} ) - Δ {Ψ}_{2} {cos}^{2} ( {ϕ}_{1} )}{{cos}^{2} ( {ϕ}_{2} ) - {cos}^{2} ( {ϕ}_{1} )} + ( \frac{1 - 2 v}{E} {κ}_{ε} - {κ}_{P} ) Δ {P}_{ext} - \frac{{κ}_{ε} ( {r}_{0 , ext}^{2} + ( 1 - 2 v ) {r}^{2} ) - {κ}_{P} {Er}^{2}}{π {Er}_{0 , ext}^{2} ( {r}_{0 , ext}^{2} - {r}_{0 , int}^{2} )} δ F )$$

where ΔT is herein the variation of the temperature at the radius r; and
κ_{P} is a sensitivity intrinsic to the hydrostatic pressure of the sensor alone, said sensitivity being equal to a proportionality coefficient between a relative variation in the monitoring quantity and a variation in the pressure hydrostatic that is directly applied thereto.

In such a configuration, the determined temperature variation ΔT of the pipe 4 is a temperature of the wall of the pipe 4 at the radius r.

And in the most general case where the sensors are positioned across the thickness of the portion 12 of the pipe 4, respectively at a radius r₁ and a radius r₂:

$$Δ T = \frac{{r}_{1}^{2} {r}_{2}^{2} ( Δ {Ψ}_{1} - Δ {Ψ}_{2} ) ( {κ}_{ε} ( 1 - 2 v ) - {κ}_{P} E )}{{κ}_{T} {κ}_{ε} ( 1 + v ) {r}_{0 , ext}^{2} [ {r}_{1}^{2} {cos}^{2} ( {ϕ}_{2} ) - {r}_{2}^{2} {cos}^{2} ( {ϕ}_{1} ) ]} + \frac{Δ {Ψ}_{1} {r}_{1}^{2} {cos}^{2} ( {ϕ}_{2} ) - Δ {Ψ}_{2} {r}_{2}^{2} {cos}^{2} ( {ϕ}_{1} )}{{κ}_{τ} [ {r}_{1}^{2} {cos}^{2} ( {ϕ}_{2} ) - {r}_{2}^{2} {cos}^{2} ( {ϕ}_{1} ) ]} + \frac{1}{{κ}_{τ}} ( \frac{1 - 2 v}{E} {κ}_{ε} - {κ}_{P} ) Δ {P}_{ext} + \frac{\begin{matrix}{κ}_{ε} [ ( {r}_{2}^{2} - \text{?} ) ( {cos}^{2} ( {ϕ}_{1} ) + {cos}^{2} ( {ϕ}_{2} ) - 2 ( 1 + v ) {cos}^{2} ( {ϕ}_{1} ) {cos}^{2} ( {ϕ}_{2} ) ) + \\ ( {r}_{2}^{2} + {r}_{1}^{2} ) ( {cos}^{2} ( {ϕ}_{1} ) + {cos}^{2} ( {ϕ}_{2} ) ) ]\end{matrix}}{2 {κ}_{τ} π E ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} δ F - \frac{1}{{κ}_{τ}} ( \frac{1 - 2 v}{E} {κ}_{ε} - {κ}_{P} ) \frac{{r}_{1}^{2} {r}_{2}^{2} [ {cos}^{2} ( {ϕ}_{2} ) - {cos}^{2} ( {ϕ}_{1} ) ]}{π {r}_{0 , ext}^{2} ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} δ F$$

$$\text{?} \text{indicates text missing or illegible when filed}$$

where r₁ is a radius of the portion 12 of the pipe 4 at a predetermined reference time point associated with the angle ϕ₁;
r₂ is a radius of the portion 12 of the pipe 4 at a predetermined reference time point associated with the angle ϕ₂;
Kₚ is a sensitivity intrinsic to the hydrostatic pressure of the sensor alone, said sensitivity being equal to a proportionality coefficient between a relative variation in the monitoring quantity and a variation in the pressure hydrostatic that is directly applied thereto.

In such a configuration, the determined temperature variation ΔT of the pipe 4 is a temperature of the wall of the pipe 4, intermediate between the radii r₁ and r₂.

Similarly, and in an identical manner as for the determination of the pressure variation, the values of the radii r_{0,int}, r_{0,ext}, r, r₁, and r₂, indicated hereinabove, are reference values determined at the reference time point, as an initial time point since, given the forces exerted on the pipe 4, these values are brought to evolve.

Advantageously, the calculator 8 is also configured to measure, based on a signal output by a pressure sensor 22 (included or not included in the measurement device 2) arranged in the pipe 4, a pressure (so-called the “reference pressure”) of a fluid present in the pipe 4.

In this case, the calculator 8 is also configured to determine a damage parameter based on a discrepancy between the variation in the calculated internal pressure ΔPᵢₙₜ and a concomitant variation in the measured reference pressure.

For example, the damage factor is equal to the ratio between, on the one hand, the discrepancy between the reference pressure variation and the calculated internal pressure variation ΔPᵢₙₜ and, on the other hand, the reference pressure variation.

Preferably, the calculator 8 is also configured to generate an alert signal if the determined damage parameter is outside a predetermined tolerance range.

The operation of the measurement device 2 will now be described.

First, the sensors 6 are arranged so that each sensor 6 outputs a measurement signal indicative of the monitoring variable associated with a measurement area 10 and with a respective measurement direction.

Among all of the sensors 6, at least one first sensor 6A is such that the corresponding measurement direction defines a first angle with a plane normal to the longitudinal axis, and a second sensor 6B is such that the corresponding measurement direction defines a second angle with a plane normal to the longitudinal axis X-X. The first angle and the second angle have different absolute values modulo π.

The calculator 8 receives the corresponding measurement signal from each sensor 6, and in particular the first sensors 6A and the second sensors 6B, and measures the corresponding monitoring quantity from each measurement signal.

More specifically, for each sensor 6, the calculator 8 calculates a relative variation in the corresponding monitoring quantity.

Furthermore, the calculator 8 receives a piece of information representative of a value of the variation in the external pressure ΔPₑₓₜ, and of the variation in the additional longitudinal force 5F applied to the pipe 4, distinct from a variation in a longitudinal force by the internal pressure variation and the external pressure variation.

The calculator also calculates the variation in the internal pressure of the pipe 4, based on the variation in the external pressure, the variation in the additional longitudinal force and the measured monitoring quantities, among which at least the first measured monitoring quantity associated with the first sensor 6A and the second measured monitoring quantity associated with the second sensor 6B.

Preferably, the calculator 8 also calculates the variation in the contact temperature of the portion 12 of the pipe 4 based on the measured monitoring quantities.

Furthermore, the calculator 8 determines the damage parameter based on the calculated internal pressure variation ΔPᵢₙₜ, and generates an alert signal if the determined damage parameter is outside the predetermined tolerance range.

1. A method for measuring a variation in an internal pressure and/or a variation in a temperature of a pipe including a portion extending along a longitudinal axis, comprising:
for each of at least two measurement areas of the portion of the pipe, measuring, using a corresponding sensor, monitoring quantity associated with a respective measurement direction, a relative variation in the monitoring quantity being representative of a variation in a corresponding local deformation of the pipe according to the associated measurement direction; and
calculating the variation in the internal pressure and/or the variation in the temperature of the pipe based on at least one deformation variation, each deformation variation being obtained only based on measured monitoring quantities, among which at least one first measured monitoring quantity is associated with a first measurement direction and at least one second measured monitoring quantity is associated with a second measurement direction,
the first measurement direction defining a first angle with a plane normal to the longitudinal axis, the second measurement direction defining a second angle with a plane normal to the longitudinal axis, the first angle and the second angle having different absolute values modulo π, and
the sensors being selected so that a same variation in their temperature results in a same relative variation in their respective measured monitoring quantities.

2. The measurement method according to claim 1, wherein the measuring is preceded by fastening the corresponding sensor to each measurement area,
the sensors being fastened to respective measurement areas according to a same fastening method, and being selected so that a same variation in a mechanical deformation applied thereto results in the same relative variation in their respective measured monitoring quantities.

3. The measurement method according to claim 2, comprising:
measuring the variation in the internal pressure of the pipe wherein
the portion of the pipe has an axisymmetric cylindrical shape,
each measurement area belongs to a section of the portion of the pipe, the pipe being closed at its ends,
the variation of the internal pressure is calculated according to:
$$Δ {P}_{int} = Δ {P}_{ext} + \frac{{r}_{1}^{2} {r}_{2}^{2}}{{r}_{0 , int}^{2} {r}_{0 , ext}^{2}} [ \text{} \frac{E ( Δ {Ψ}_{{2}^{-}} Δ {Ψ}_{1} ) ( {r}_{0 , ext}^{2} - {r}_{0 , int}^{2} )}{{κ}_{ε} ( 1 + v ) [ {r}_{1}^{2} {cos}^{2} ( {ϕ}_{2} ) - {r}_{2}^{2} {cos}^{2} ( {ϕ}_{1} ) ]} + \frac{{cos}^{2} ( {ϕ}_{2} ) - {cos}^{2} ( {ϕ}_{1} )}{π [ {r}_{1}^{2} {cos}^{2} ( {ϕ}_{2} ) - {r}_{2}^{2} {cos}^{2} ( {ϕ}_{1} ) ]} δ F ]$$
where ΔPᵢₙₜ, is the variation of the internal pressure;
ΔΨ₁ and ΔΨ₂ are respectively a relative variation of the first monitoring quantity and a relative variation of the second monitoring quantity;
r_{0,ext} is an outer radius of the portion of the pipe;
r_{0,int} is an inner radius of the portion of the pipe;
r₁ is a radius at which the measurement associated with the first measurement direction is performed;
r₂ is a radius at which the measurement associated with the second measurement direction is performed;
E is the Young's modulus of the material in which the portion of the pipe is made;
v is the Poisson's ratio of the material in which the portion of the pipe is made;
φ₁ and φ₂ are respectively the first angle and the second angle;
ΔPₑₓₜ is a variation in an external pressure applied to the portion of the pipe;
δF is a variation in an additional longitudinal force applied to the portion of the pipe, and distinct from a variation in a longitudinal force exerted on the portion of the pipe by the internal pressure variation and the external pressure variation; and
κ_{ε} is a mechanical sensitivity of the sensors, equal to a proportionality coefficient between a relative variation in the monitoring quantity and a variation in the mechanical deformation applied thereto.

4. The measurement method according to claim 3, wherein, for at least one measurement area, the corresponding sensor is an optical fibre segment in which a Bragg grating is inscribed, the optical fibre segment being fastened to the measurement area so that a corresponding Bragg grating extends along the measurement direction associated with the measurement area,
the mechanical sensitivity κ_{ε} being expressed as:
$${κ}_{ε} = \frac{1}{{n}_{eff}} \frac{\partial {n}_{eff}}{\partial {ε}_{mec}} + 1$$
where n_{eff} is an effective index of an optical guide of the optical fibre; and
ε_{mec} is a longitudinal mechanical deformation of the optical fibre,
the monitoring quantity being a reflection wavelength of each Bragg grating.

5. The measurement method according to claim 4, wherein, for at least two measurement areas, the corresponding optical fibre segments belong to a same optical fibre.

6. The measurement method according to claim 5, wherein measurement axes associated with at least two optical fibre segments of the same optical fibre form, with the longitudinal axis of the portion of the pipe, angles that are distinct, in absolute values, modulo π.

7. The measurement method according to claim 5, wherein the measurement areas on which at least two optical fibre segments of the same optical fibre are fastened are arranged along a generatrix of the portion of the pipe.

8. The measurement method according to claim 1, wherein, for at least one measurement area, the sensor is selected from the group comprising distance sensors, sensors implementing a reflectometry method on an electrical cable, sensors implementing an optical reflectometry method, deformation gauges and stereo-correlation deformation sensors.

9. The measurement method according to claim 1, wherein the first angle is 0 modulo π, and the second angle is π/2 modulo π.

10. The measurement method according to claim 9, comprising:
measuring a variation in the temperature of the pipe and the portion of the pipe has an axisymmetric cylindrical shape, each measurement area belonging to a section of the portion of the pipe, the pipe being closed at its ends, and
calculating the variation in the temperature of the pipe according to:
$$Δ T = \frac{{r}_{1}^{2} {r}_{2}^{2} ( Δ {Ψ}_{1} - Δ {Ψ}_{2} ) ( {κ}_{ε} ( 1 - 2 v ) - {κ}_{P} E )}{{κ}_{T} {κ}_{ε} ( 1 + v ) {r}_{0 , ext}^{2} [ {r}_{1}^{2} {cos}^{2} ( {ϕ}_{2} ) - {r}_{2}^{2} {cos}^{2} ( {ϕ}_{1} ) ]} + \frac{Δ {Ψ}_{1} {r}_{1}^{2} {cos}^{2} ( {ϕ}_{2} ) - Δ {Ψ}_{2} {r}_{2}^{2} {cos}^{2} ( {ϕ}_{1} )}{{κ}_{τ} [ {r}_{1}^{2} {cos}^{2} ( {ϕ}_{2} ) - {r}_{2}^{2} {cos}^{2} ( {ϕ}_{1} ) ]} + \frac{1}{{κ}_{τ}} ( \frac{1 - 2 v}{E} {κ}_{ε} - {κ}_{P} ) Δ {P}_{ext} + \frac{\begin{matrix}{κ}_{ε} [ ( {r}_{2}^{2} - {r}_{1}^{2} ) ( {cos}^{2} ( {ϕ}_{1} ) + {cos}^{2} ( {ϕ}_{2} ) - 2 ( 1 + v ) {cos}^{2} ( {ϕ}_{1} ) {cos}^{2} ( {ϕ}_{2} ) ) + \\ ( {r}_{2}^{2} + {r}_{1}^{2} ) ( {cos}^{2} ( {ϕ}_{1} ) + {cos}^{2} ( {ϕ}_{2} ) ) ]\end{matrix}}{2 {κ}_{τ} π E ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} δ F - \frac{1}{{κ}_{τ}} ( \frac{1 - 2 v}{E} {κ}_{ε} - {κ}_{P} ) \frac{{r}_{1}^{2} {r}_{2}^{2} [ {cos}^{2} ( {ϕ}_{2} ) - {cos}^{2} ( {ϕ}_{1} ) ]}{π {r}_{0 , ext}^{2} ( {r}_{0 , ext}^{2} - {r}_{0 , int}^{2} ) [ {r}_{1}^{2} {cos}^{2} ( {ϕ}_{2} ) - {r}_{2}^{2} {cos}^{2} ( {ϕ}_{1} ) ]} δ F + {ϵ}_{surf} \frac{1}{{κ}_{τ}} ( \frac{{κ}_{P}}{π ( {r}_{0 , ext}^{2} - {r}_{0 , int}^{2} )} δ F - \frac{( Δ {Ψ}_{1} - Δ {Ψ}_{2} ) {κ}_{P} E}{{κ}_{ε} ( 1 + v ) [ {cos}^{2} ( {ϕ}_{2} ) - {cos}^{2} ( {ϕ}_{1} ) ]} )$$
where ΔT is the variation in the temperature of the pipe;
ΔΨ₁ and ΔΨ₂ are respectively a relative variation of the first monitoring quantity and a relative variation of the second monitoring quantity;
r_{0,ext} is an outer radius of the portion of the pipe;
r_{0,int} is an inner radius of the portion of the pipe;
r₁ is a radius at which the measurement associated with the first measurement direction is performed;
r₂ is a radius at which the measurement associated with the second measurement direction is performed;
∈_{surf} is a parameter that takes a value 1 when r₁ and r₂ are both equal to r_{0,int} or both equal to r_{0,ext} and a value 0 in the other cases;
E is the Young's modulus of the material in which the portion of the pipe is made;
v is the Poisson's ratio of the material in which the portion of the pipe is made;
φ₁ and φ₂ are respectively the first angle and the second angle;
ΔPₑₓₜ is a variation in an external pressure applied to the portion of the pipe;
δF is a variation in an additional longitudinal force applied to the portion of the pipe and distinct from a variation in a longitudinal force exerted on the portion of the pipe by the internal pressure variation and the external pressure variation;
κ_{ε} is a mechanical sensitivity of the sensors, equal to a proportionality coefficient between a relative variation in the monitoring quantity and a mechanical deformation variation;
κ_{T} is a thermal sensitivity of the sensors, equal to a proportionality coefficient between a relative variation in the monitoring quantity and a variation in temperature of the sensors; and
Kₚ is a sensitivity intrinsic to a hydrostatic pressure of the sensor alone, the sensitivity being equal to a proportionality coefficient between a relative variation in the monitoring quantity and a variation in the pressure hydrostatic that is directly applied thereto.

11. The measurement method according to claim 1, wherein N measurement areas are circumferentially distributed every 2π/N around the longitudinal axis, N being an integer strictly greater than 1, for at least two distinct ones of the N measurement areas, and the corresponding monitoring quantities are associated with measurement directions defining, with a plane normal to the longitudinal axis, angles having opposite signs modulo π.

12. The measurement method according to claim 1, wherein the measurement associated with the first measurement direction and the measurement associated with the second measurement direction are performed at a same surface of the portion of the pipe selected from among an inner surface and an outer surface of said portion of the pipe.

13. The measurement method according to claim 1, further comprising:
measuring, using a pressure sensor arranged in the pipe, a pressure of a fluid present in the pipe, forming a reference pressure;
calculating a damage parameter based on a discrepancy between the variation in the calculated internal pressure and a concomitant variation in the reference pressure; and
generating an alert signal if the determined damage parameter is outside a predetermined tolerance range.

14. A device for measuring a variation in an internal pressure of a pipe including a portion extending along a longitudinal axis, comprising:
at least two sensors and a calculator,
each sensor being configured so as to output, for a corresponding measurement area of the portion of the pipe, a measurement signal indicative of a predetermined monitoring quantity associated with a respective measurement direction, a relative variation in the monitoring quantity being representative of a variation in a local deformation, according to an associated measurement direction, of the measurement area,
the sensors being selected so that a same temperature variation results in a same relative variation in their respective measured monitoring quantities,
the calculator being configured to measure the corresponding monitoring quantity based on each measurement signal,
the calculator being further configured to calculate the variation in the internal pressure of the pipe based on at least one deformation variation, each deformation variation being obtained only from the measured monitoring quantities, among which at least one first measured monitoring quantity is associated with a first measurement direction and at least one second measured monitoring quantity is associated with a second measurement direction, and
the first measurement direction defining a first angle with a plane normal to the longitudinal axis, the second measurement direction defining a second angle with a plane normal to the longitudinal axis, and the first angle and the second angle having different absolute values modulo π.

15. An apparatus comprising a pipe and a measurement device according to claim 14, the pipe including a portion extending along a longitudinal axis,
each sensor of the measurement device being associated with a respective measuring area of an outer surface of the portion of the pipe, and being arranged so as to provide a monitoring quantity associated with a respective measurement direction, a relative variation in the monitoring quantity being representative of a variation in a corresponding local deformation of the pipe according to the associated measurement direction, and
at least one first measurement direction defining a first angle with a plane normal to the longitudinal axis, and at least one second measurement direction defining a second angle with the plane normal to the longitudinal axis, the first angle and the second angle having different absolute values modulo π.

16. The measurement method according to claim 8, wherein the distance sensors implement an acoustic method between an acoustic emitter and an acoustic receiver, and the deformation gauges are electrical deformation gauges.

17. The measurement method according to claim 11, wherein N is an even number greater than 2.
